(19) United States
(12) Patent Application Publication
(10) Pub. No.: US 2002/0151363 A1
(43) Pub. Date: Oct. 17, 2002

(54) Method and system for broadcast and control of a remotely located wagering device

(76) Inventors: Howard Letovsky, Willits, CA (US); Tony Fontaine, Henderson, NV (US); Gary Ramos, Willits, CA (US)

Correspondence Address: W. Jackson Matney, Jr., Milbank, Tweed, Hadley & McCloy LLP, International Square Building, 1825 Eye Street, N.W., Washington, DC, 20006, US

(21) Appl. No.: 09/833,448

(22) Filed: Apr. 12, 2001

(51) Int. Cl. G06F 19/00

(52) U.S. Cl. 463/40

(57) ABSTRACT

The invention consists of a method, apparatus, and data structure that allows a player remotely located from wagering devices, such as slot machines, video lottery terminals (VLTs), etc., to make wagers on the wagering devices using funds on deposit in an account. The remote player may establish a communication link to the location where the wagering devices are housed through a remote-access service. After authentication of the player's identity, the player may be provided with a menu of available wagering devices. A wagering device computer network server, preferably coupled to video cameras, may transmit the image of the selected wagering device, or as appropriate, the video output of the wagering device, through telecommunications media, to the player. A pop-up control panel on the player's remote viewing system may provide graphical representations of the game play inputs of the actual wagering device, as well as a graphical display of current funds on account. The player may deposit money from an account directly into the wagering device via software controlled by icons in the pop-up control panel. The player then operates the selected device remotely through the graphical representations of the game play inputs in the pop-up control panel. Game play proceeds as per the attributes of the wagering device. Game play records and accounting may be kept on the wagering device, and the wagering device network server. The status of the player's current amount of money on deposit in the wagering device may be displayed on the device and transmitted to the player's remote viewing system in the video broadcast process. Upon conclusion of the gaming session, any money remaining on deposit in the wagering device may be transferred to the player's account.

### FIELD OF THE INVENTION

The present invention relates to a method of and apparatus for gambling. More particularly, the invention relates to network gaming systems that allow players to place wagers through any one of a variety of communications links.

### BACKGROUND OF THE INVENTION

In jurisdictions where casino gambling and slot machines are legal, slot machines account for the majority of gaming revenues. In a casino, it is common to see 70% or more of the gaming floor space dedicated to slot machines, both of the reel spinning and video varieties. Typically these machines make their return on investment based on two to four hours of play per day. They offer an experience tailored to individual play. The popularity of these machines is related to the variety of the games offered, the simplicity of the rules, and the attraction of the themes. In addition to the experience offered by the game, the player is assured that the game offers a reasonable chance of winning. This assurance is due to the game being subject to a variety of governmental and regulatory oversight. Wagering devices are highly regulated, and each machine must pass governmentally dictated requirements or it will not be approved for use. Although these regulatory requirements often vary from one gaming jurisdiction to another, the player is assured of a fair game of chance as dictated by that jurisdiction's governing regulatory body, regardless of the jurisdiction in which the machine and the player are located.

Remote-based gaming offers gaming operators the opportunity to offer gaming to remote locations and, correspondingly, provide remote users with access to gaming. The increasing popularity and number of Internet-based casinos confirms this proposition. Remote-based gaming to date has been based either on live events such as horse racing and sports wagering, or virtual games replicating the games played in traditional casino games. See, e.g., U.S. Pat. Nos. 5,800,268, to Molnick, 5,762,552, to Vuong et al., and 4,467,424, to Hedges et al., which are incorporated by reference in their entirety. Virtual games offer an operator the distinct advantage of allowing an unlimited number of users to access one software-based game. A single computer server can host a suite of games that may be accessed by a theoretically unlimited number of players. See, e.g., U.S. Pat. Nos. 5,586,937, to Menahse, 6,080,063, to Khosla, and 6,117,011, to Lvov, which are incorporated by reference in their entirety. The use of virtual games for wagering has three major disadvantages for the operator and the player: high software development costs, the time and costs associated with the regulatory approval process, and lack of consumer confidence in the honesty of the game. The present invention alleviates these disadvantages while providing a higher return on investment than found in a traditional casino.

### SUMMARY OF THE INVENTION

The present invention provides a unique and novel means to allow a wagering device to be observed, controlled, and played from a remote location. With the invention, existing, previously approved wagering devices may be used. This effectively nullifies the need for ongoing software game development. It also creates a new secondary market for used wagering devices. The approval cycle for implementing the remote play version is shortened considerably because the wagering devices have already undergone the regulatory approval cycle before being customized for remote play. Correspondingly, the costs of regulatory approval are reduced significantly.

The present invention also provides the consumer with increased confidence in the games offered. Given this increased consumer confidence and the nature of the Internet, the amount of time played on each wagering device will increase correspondingly. Instead of two to four hours of play per day, a device may be played twenty-four hours a day on the Internet. The revenue generated by a wagering device employed in the invention can generate six to twelve times the revenue per day as the same wagering device found on a casino floor.

In a preferred embodiment of the present invention, the user may access the gaming system via the Internet. In cases where legal restrictions on Internet gaming prohibit such access, an appropriate communications medium, such as a private or virtual private network may be used. In one preferred embodiment, the gaming system will provide a visual display and selection of available wagering devices, and a video presentation of the wagering device selected. This display may either be a virtual rendition of the wagering devices or the wagering devices themselves. The wagering devices as referenced herein may be traditional standalone gaming devices such as reel spinning slot machines, video based slot machines, video lottery terminals (VLTs), or any other suitable electrical and/or mechanical gaming device, such as single user video game machines for playing black jack, poker, craps, baccarat, keno, roulette, and the like. Typically, these devices provide for standalone play; however, they may be networked together to provide for progressive jackpots.

The remote player interface is an element of the present invention that uses a client-based graphical user interface (GULI), or web page, to graphically and functionally replicate the input controls of the wagering device as a graphical remote control panel on a remote player's computer. In one preferred embodiment, instead of pressing the button on the wagering device to activate a command such as bet, spin, or any other available command, the remote player interface will receive the corresponding input from the player's remote control panel and activate the associated command. The remote player interface may also be used to debit and credit money into a player's account based upon input from the remote control panel. Video cameras may be positioned to capture all of the features of the game play. In the case of any dispute, all game play records are captured on the wagering device with date and time stamps that may be compared to archived video recordings of the game play.

Due to the large amount of data associated with the video output, a remote player will ideally have a high-bandwidth connection to the gaming system in a preferred embodiment. However, in order to accommodate lower data transmission speeds, the present invention may incorporate elements that enable automatic bandwidth detection and optimization of a user's data transmission speed. The gaming system may sense the bandwidth of a remote player's connection and automatically optimize the video output presentation in accordance the capabilities of the remote player's system. The invention may include various methods of encrypting, buffering, and displaying to enable such optimization. These methods may include activating compression codecs to control the frame rate for a given frame size for a given resolution. The compression codecs may minimize the frame bit size with the file then streamed to the remote player. Preferably, a combination of compression codecs in conjunction with hardware compression and file packaging/delay will assure that each remote user may get a full-motion video experience. It is understood that the methods for transmitting data described herein are merely illustrative; any suitable transmission methods and apparatus may be implemented.

Although intended for wagering purposes, in an alternative embodiment, the invention may be used for “play for fim” contests where no actual wagering is involved. Depending upon local regulations, an admission fee may or may not be collected. The award of prizes may also be subject to prevailing contest regulations.

In still another embodiment, a proxy, on behalf of remote users, may perform the remote player capabilities of the invention. This proxy may be human or mechanical, and may represent one or more players by physically performing inputs to the wagering device.

An interactive gaming system for enabling at least one remotely located player to place wagers on at least one remotely located wagering device of chance and providing the remotely located player with the ability to view game play and outcome from the remotely located wagering device in real time is disclosed. The system includes a communications network infrastructure having audio, video and data communications to and from a remote location, IP routing capability to various servers, associated peripherals required for storage and security, wagering devices, video cameras, software providing access to a player account to determine information and account status, debiting and crediting the account, and transference of funds -between accounts, and archival capabilities for game play having audio and video records with date and time stamps.

Another disclosed system provides at least one controller coupled to at least one wagering device wherein the controller may accept input from a remote location and trigger the proper functions associated with the corresponding input on the wagering device, software configured to manage the controller, an associated graphical user interface defining a remote player console that is resident on a remote computer replicating the game play inputs located on a physical wagering device, software designed to accept input to the remote player console, and software facilitating communications to and from the physical wagering device.

Another system provides a video server that includes hardware and software capable of real-time or near real-time audio and video capture of the game play and outcome of a wagering device; hardware and software capable of real-time or near real-time transmission of the captured audio and video of the game play and outcome of a wagering device; hardware and software capable of the optimization of file size based upon input from the automatic bandwidth detection and optimization system; and hardware and software capable of transmission of the optimized file to at least one gaming server.

Still another system discloses wagering device nodes wherein the nodes include the association and coordination of at least one wagering device with at least one video camera, and the real-time or near real-time audio and video transmission of game play and the outcome of the wagering device to a server and a player's computer simultaneously.

Another disclosed system provides at least one wagering device server wherein the server may be configured with hardware and software to poll at least one wagering device for play availability, to provide a graphical user interface to a remote player that displays the availability of the wagering device based upon the polling function, to provide a remote player the ability to select an available wagering device via the graphical user interface, to route at least one remote player to a selected available node for game play, to activate the corresponding remote player interface, to provide a display of the remote player console corresponding to the selected wagering device to a remote player via the graphical user interface, to provide data communication between the remote player console and the gaming nodes, and to provide data communication between the player accounting system, the remote player console, and the remote player interface.

Another system provides a player accounting system configured to capture a remote player's and/or a remote player's affiliate game play time, to interface with a player tracking and accounting system, to interface with the remote player interface for transactions between the player tracking and accounting system and a remote player, to provide a remote player graphical user interface presenting account status and wagering icons, to provide an interstitial account server which may act as the wagering device bank in which the funds are kept to debit and/or credit the results of game play to a player account, to provide transferring of funds to/from a remote player's account from/to a physical wagering device, and to provide a remote player graphical user interface representation of the transference of finds to/from a remote player's account from/to a physical wagering device.

Another system in accordance with the invention includes a method and practice for wagering device operations wherein wagering devices may be aggregated in one common area, or “slot farm,” for the purpose of accepting wagers from a person or persons remotely located from the slot farm via a Local Area, Wide Area, Private, Intra and/or Internet Network and may be operated by an on-line casino or time-share operator and may be controlled by a routing/traffic management server 90. The slot farm may consist of the gaming system and one or more wagering devices where the on-line casino operator may procure, implement, and manage the gaming system. In another embodiment, time-share operators may offer slot farm services for a fee. In yet another system, the system is managed for profit by leasing time of at least one wagering device to a third-party with or without consideration, sharing of revenue generated on a device by a third-party customer, and marketing and conducting of contests and/or tournaments, with or without consideration.

In another aspect of the invention, a system for remotely controlling at least one wagering device using a user computer contains a computer-readable memory for storing data for access by an application program and includes a data structure stored in the computer-readable memory. The data structure may include information used by the application program and may contain a plurality of personal data fields, financial fields, wagering device control fields, wagering fields, and results fields. The application program may use the field values to control the operation of the at least one wagering device. In various aspects, a plurality of fields, such as video display fields, account balance fields, archival fields, date fields, time fields, bandwidth fields, and transmission speed fields, may be employed in varying manners and combinations to permit control of a wagering device from a remote location.

The invention as described herein has several advantages over prior art solutions. A more complete understanding of the present invention, as well as further features and advantages will be obtained by reference to the following drawings, detailed description, and claims.

### BRIEF DESCRIPTION OF THE DRAWINGS

FIG. 1 is a schematic block diagram illustrating an exemplary method for providing a visual display and selection of wagering devices, and a video presentation of the wagering device selected, to remote players via the Internet, or over private or virtual private networks, according to the principles of the invention.

FIG. 2 is a schematic block diagram illustrating a remote player interface that graphically and functionally replicates the input controls of the wagering device as a graphical remote control panel on a remote player's computer, according to the principles of the invention.

FIG. 3 is a schematic block diagram illustrating an example of a wagering device slot farm, according to the principles of the invention, wherein the wagering devices are coupled to a local area or wide area network, and the network is linked to video cameras positioned to capture and transmit archived video recordings of all the features of the game play with date and time stamps.

FIG. 4 is a schematic block diagram illustrating another example of a wagering device slot farm, according to the principles of the invention, wherein the wagering devices are connected to gaming servers that are coupled to a routing/traffic management server over a local area or wide area network connection, and the network is linked to video cameras positioned to capture and transmit archived video recordings of all the features of the game play with date and time stamps.

FIG. 5 is a schematic block diagram illustrating a high bandwidth connection to a gaming system, as well as elements that enable automatic bandwidth detection of a remote user's data connect speed, and the subsequent optimization of visual image and data transmission through encryption and buffering, according to the principles of the invention.

### DETAILED DESCRIPTION OF THE INVENTION

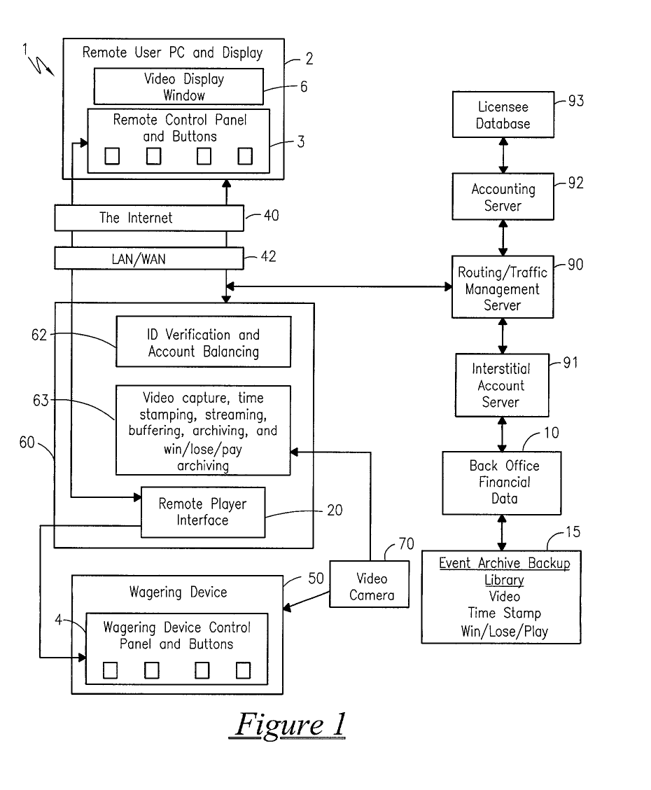

In a preferred embodiment, as shown in FIG. 1, a remote gaming apparatus 1 may include a remote user computer 2 with a visual display 6 and a remote control panel 3. User computer 2 may be an ALPHA server, a minicomputer, a microcomputer, a UNIX machine, a mainframe computer, a personal computer with an Intel Pentium processor, a Macintosh personal computer, a laptop, a personal data assistant (PDA), a pen computer, a kiosk or any other suitable computer. Of course, it is understood that a plurality of user computers may be employed in accordance with the principles of the invention. The graphically represented remote control panel 3 may be equipped with buttons or any other suitable manipulatable members. Use of user computers 2 to control wagering devices may be accomplished via a Web-style environment of point-and-click that directly links a user to desired sections. It is understood that selecting, pointing, clicking, choosing, and the like refer to the use of buttons, a mouse and mouse pointer, a stylus, a keyboard, a touch screen interface, or any other device for selecting according to the principles of the invention. In this embodiment, there may also be one or more wagering devices 50 fitted with a wagering device control panel 4. The wagering device control panel 4 is preferably equipped with remotely controllable buttons or any other suitable selecting member(s). Wagering device 50 of the invention may include any number of electrical and/or mechanical devices, including reel type and video slot machines, video lottery terminals, video keno terminals, single user video game machines, which may include black jack, poker, craps, baccarat, keno, roulette, and any other game that may be electrically and/or mechanically observed and remotely controlled. In addition, there may be one or more of a plurality of video cameras 70 that presents the selected wagering device 50 to remote players via a gaming server 60. A direct video connection may also be employed, alone or in combination with one or more video camers 70, that presents the selected wagering device 50 to remote players. Server 60 may be an ALPHA server, a minicomputer, a microcomputer, a UNIX machine, a mainframe computer, a personal computer with an Intel Pentium processor, a Macintosh personal computer, or any other suitable computer. Server 60 may also be configured as a series of gaming servers managed by a routing/traffic management server 90, or accessed independently through network addresses. As depicted in FIG. 1, a video signal generated by a particular video camera 70 may also be transmitted through a network 40 and additional local or wide area networks 42 to a back office financial data server 10, an event archive backup library server 15, an interstitial account server 91, or other desired ancillary account servers 92. In a preferred embodiment, server 60 is a World Wide Web server connected to the Internet. The network is preferably the Internet, however, any network or connection, such as a telephone link, a hard-wired connection, a satellite link or other wireless connection, a local area network (LAN), a wide area network (WAN), any combination of the preceding, or any other suitable type of connection may be employed according to the principles of the invention. Preferably, server 60 has an operating system that is capable of supporting one or more users, and multi-tasking, such as UNIX, Windows NT, or LINUx. Multiple user computers 2 may communicate simultaneously with server 60, and each connection may be by a different type of link, e.g., one connection may be by telephone while another may be by the Internet. Similarly, multiple external databases 93, such as those operated by an on-line casino or time-share operator, for example, may communicate simultaneously with server 60, and each connection may be a different type of link as discussed above. In one embodiment, multiple user computers and multiple external databases may communicate with servers 60 and wagering devices 50 via routing/traffic management servers 90. Server 60 may communicate with a particular database by a variety of communication protocols, including file transfer protocol (FTP), electronic mail (e-mail), transfer control protocol/Internet protocol (TCP/IP), ASCII, X-MODEM, Y-MODEM, KERMIT, any combination of the preceding protocols, or any other suitable type of protocol.

Gaming establishments are legally bound to ensure that customers are of legal age to participate in the play of casino games. One method is to check the identification of customers. Fingerprint authentication is another method that may be employed through the use of software and hardware, including an ergonomically designed, intelligent peripheral sensor with a Universal Serial Bus (“USB”) connector adaptable for utilization in connection with a user computer keyboard and capable of confirming the customer identity upon each logon to the operating system of the invention. Another manner of authenticating a user is to capture the user's personal computer information upon installation and then to perform a comparison upon each login by the user to verify identity. The system may display a message indicating the last date/time that the system was accessed, which may alert the customer of any unauthorized access. In the event of unauthorized access, the user will be prompted to change the password to access the system. Another account security feature permits a customer to establish a daily or other periodic limit on gambling losses. An operator of the remote gaming apparatus 1 provides a remote player or players with the ability to wager on a wagering device 50 based on the player's financial information stored in back office financial data server 10. A remote player may select a “wagering amount” from the player's account employing user computer 2. The system may be designed to convey the game-play outcome of a wagering device 50 to a remote player, utilizing a real-time, or slightly delayed, video feed.

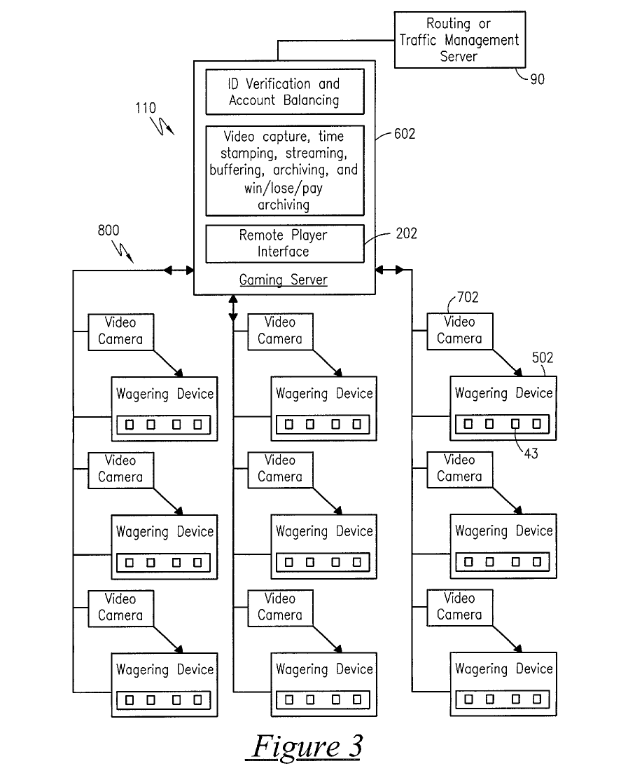

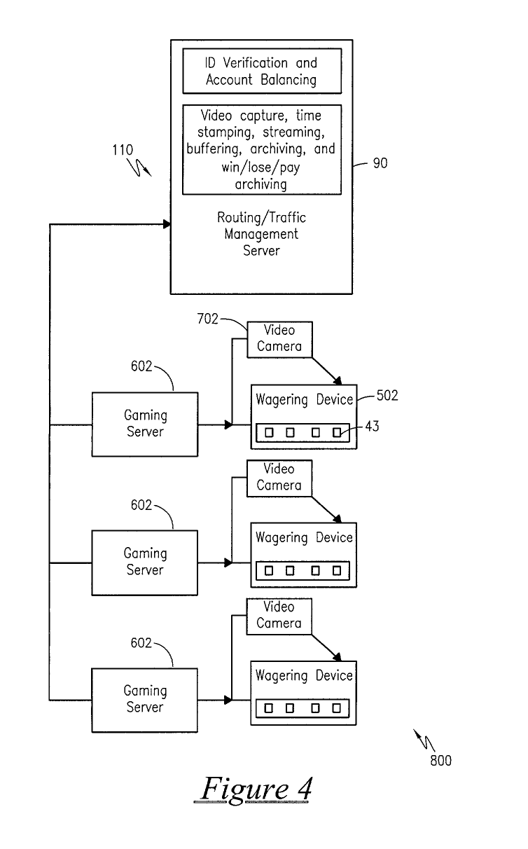

Upon access to the remote user computer 2 of the remote gaming apparatus 1, a gaming server 60 may poll the wagering devices 50 in order to determine availability and may query a player's account stored in back office financial data server 10 as is depicted in FIG. 3. In another embodiment represented by FIG. 4, a routing/traffic management server 90 may poll the gaming servers 60 in order to determine availability and may query a player's account in any of the financial servers. Back office financial data server 10 may be configured in combination with verification and account balancing unit 62 as a typical online banking database with user logon and password functions linking users to their accounts. Account reconciliation is performed in real time by balancing game wins or losses with the associated dollar amounts on a per-credit basis by employing verification and account balancing unit 62 where per-credit refers to the number of credits reflected on a wagering devices credit meter, which may reflect credits in any one of a number of denominations including nickels, dimes, quarters, dollars or any other denomination appropriate for the jurisdiction of play. Video capture of significant time-stamped frames of game play may be archived to establish a visual record of a specific wagering device 50 used at a given time by a remote player by utilizing video camera(s) 70 in combination with video capture unit 63 and event archive backup library server 15. The player may then be presented with a wagering device selection page on the visual display 6. This page may display the physical representation of the wagering devices 50 available for play. This page may also initiate a pop-up player account control panel that provides current account information and funds available for play. This account window may also provide the player with a graphical representation of his or her funds and the ability to “drag and drop” funds from his or her account into a particular wagering device 50.

A player may establish an account with the wagering device operator through direct deposit at an operator's physical location, or by any other legitimate method of funds transfer. These funds may be held in a player's account for later game play.

After selecting a wagering device 50, the gaming server 60 routes the player's remote user computer 2 to the selected wagering device 50. Each gaming server 60 may have a fixed IP address, or may be assigned a discreet Internet protocol (IP) address by the routing/traffic management server 90. Once the player's remote user computer 2 is routed through a gaming server 60 to the selected wagering device 50, the associated one or more video cameras 70 may be activated and the user may be given a video feed of the wagering device 50. In combination with the video feed a wagering device control panel may be presented to the player on the visual display 6 of the remote user computer 2. Preferably, this panel mimics the game play inputs located on the physical wagering device 50. In one embodiment a graphically represented pop-up control panel is provided.

The routing/traffic management server 90 may be employed to interface with one or more gaming servers 60 to facilitate routing of the player's remote user computer 2 to the wagering device 50. The routing/traffic management server 90 may handle the initial user identity verification, may identify an available gaming server and associated wagering device, and may link the user's computer with the gaming server. Routing/traffic management server 90 may also handle secondary user identity verification, in a case where a user's identify is verified by a third-party licensee, such as an on-line casino or time-share operator. In this aspect, the third-party licensee may verify that the user is authentic and has sufficient funds available for gaming and then may pass the user to the routing/traffic management server 90. Here, the user may be given access to the wagering devices 50 based on agreements with the third-party licensee as the identity of the user may remain unknown to the routing/traffic management server 90. In one embodiment, the routing/traffic management server 90 verifies that the user was passed from a licensed third party and that the licensed third party has sufficient monetary reserves to cover the potential winnings of the user. After a user is accepted by the routing/traffic management server 90 and given access to wagering devices 50, the routing/traffic management server 90 drops the audio and video feed to maximize bandwidth for additional users; however, the routing/traffic management server 90 may maintain a continuous data connection to the gaming servers 60 in use so that the gaming results may be stored in a number of databases. When a user logs off, the gaming server 60 may reconcile its own internal account database, and may then reconnect with interstitial account server 91, the accounting server 92, or any other server associated with a database through the routing/traffic management server 90, whereby all accounts may be reconciled. For example, the interstitial account server 91 may be an account maintained by a third-party licensee. In one embodiment, a number of licensees' accounts may be maintained by one or more interstitial account servers that facilitate monitoring and regulating a contractually agreed-upon buffer balance, permissioning and authenticating codes and software, and other features associated with tracking operations. Other servers, such as ancillary account servers, may be constructed to capture the type of information required by governing bodies, such as state licensing boards, state and federal taxing agencies, and the like, which require redundant databases for various purposes.

Prior to play, the player may position the mouse cursor over the representation of funds in the account window and may select a desired wager. The wager may then be entered numerically or dragged across the screen of the visual display 6 and dropped onto the area of the screen designed to facilitate the transfer of the wagered amount from the players account directly into the appropriate remote play mechanism of wagering device 50, or, in the alternative, the wagered amount may be used as a deposit to allow a player to use a wagering device 50 that has been enabled for play with credits by the system operator. The remote play mechanism receives the software command to increment the players credit meter on the physical wagering device 50. In this aspect, once the meter has been incremented, the remote play mechanism confirms the transfer to the gaming system and the player's account may be debited. Preferably, the player's account, and the electronic link between the player's account and the wagering device 50, are locked during this transfer to prevent multiple player/device access and account overdraft. The player may then see the requested wager amount displayed on the credit meter located on the physical wagering device 50 via the video feed. Concurrently, the player may also see his or her updated account information in the graphically represented pop-up account window. The fields utilized in accordance with the invention may be provided in a convenient drop-down menu or toolbar. Of course, the layout of window contents and toolbar options may be modified by the player. In a preferred embodiment, the player may aesthetically modify the layout without effecting the integrity of the accounting database or any other aspect of the invention.

The video feed may be achieved by utilizing network addressable video cameras 70 associated with individual wagering devices. These cameras may be independently network addressable and attached to a gaming server 60, or may be individually attached to dedicated (computer processors) servers that are in turn attached to a central server. The number of video cameras 70 required per wagering device 50 is dependent on the number of camera angles required, the sophistication of the cameras used, the type of wagering device 50 played, and the remote player's individual preferences. In the case of second chance or bonus wagering devices, two video cameras 70 may be utilized. In this instance, one video camera 70 would be focused on the initial game display while the second video camera 70 would be focused on the second chance or bonus display. Of course, more than two video cameras 70 may be employed according to the principles of the invention. Moreover, more sophisticated tilt and swivel camera equipment incorporating sophisticated auto-focusing technologies may be utilized to enhance the gaming experience or to minimize the need for additional cameras.

Once the player sees that the credit meter has been properly incremented, the player may move the mouse cursor to the desired wager amount as determined by the physical wagering device 50 and replicated on the wagering device control panel 4. In one aspect, upon entry to the wagering device control panel 4, a command is sent to the remote user computer 2. The player may then use the remote user computer 2 to instruct the wagering device to increment the bet meter on the physical wagering device 50.

Upon visual confirmation that the bet meter on the physical wagering device 50 has been incremented, the player may position the cursor on the game activation button (typically “play,” “spin,” or “deal”) and may press enter. In this aspect, a transmission may then be sent to the remote play mechanism, which, in turn, sends the physical wagering device the instruction to begin play.

According to principles of the invention, play continues in accordance with the attributes of the physical wagering device 50 with game play controlled by the player from the remote control panel 3. The results of individual game plays may be reflected in the credit meter on the physical wagering device 50. Game play may end when the remote player has run out of credits on the physical wagering device 50 and does not desire to continue playing, or the player wishes to collect the amount remaining on the physical wagering devices credit meter. In the first case, no account adjustment is required and the player may exit this session and return to the wagering device selection page to play another device. The aggregate amount of player losses, for example, the amount that would remain in the physical slot machine in a physical casino environment, may be debited to the interstitial account server 91, which may act as the wagering device account bank. The interstitial account server 91 may reconcile its account database with any ancillary account servers (not shown) over a secure encrypted connection. In the second case, the player requests collection via the appropriate button on the wagering device control panel 4. As discussed above, this action triggers the remote play mechanism to decrement the credit meter accordingly and transfers it over to the player's account window. During this process the player observes that the credit meter may be reset to zero and the account balance may be incremented accordingly. For example, when the win meter is equal to the aggregate amount wagered by the player, there is no interaction. In the case where the win meter is greater than the aggregate amount wagered, that amount is credited from the interstitial account server 91 and debited to the player account as winnings. Once the transaction has been confirmed by the two systems, the player may exit to the wagering device selection page to choose another wagering device 50, or simply exit the system entirely.

Final settlement of a player's account for a player that no longer desires wagering device 50 wagering may be accomplished in accordance with the terms and conditions of the operator with whom the account is carried.

In a further preferred aspect, the remote player may control the wagering device 50 by clicking visually represented buttons within the player's browser. The selection of these buttons may send ASCII commands via one or more of links 40, 42 to the gaming server 60 that may send the commands over a LAN or other suitable network to the serial port of a gaming server 60 that is interfaced to the video camera 70 viewing the wagering device 50. The output from the serial port may activate a relay card that translates the ASCII commands to a switch closure of the corresponding switch. A return command may then be sent from the switch back through the system to the gaming server 60 and the remote user's browser to confirm receipt of the remote player's command. As discussed above, wagering devices 50 may be standard wheel and video display-type slot machines, or any other suitable wagering devices, that are connected to a remote player interface. The system may be designed to allow one remote user to control one wagering device 50 at a time. In one preferred aspect, the system is operated on a first-come, first-served approach. Thus, when a remote user's logon ID is verified, and the user chooses a wagering device, that device is locked out from all other users until the first user is logged off that device.

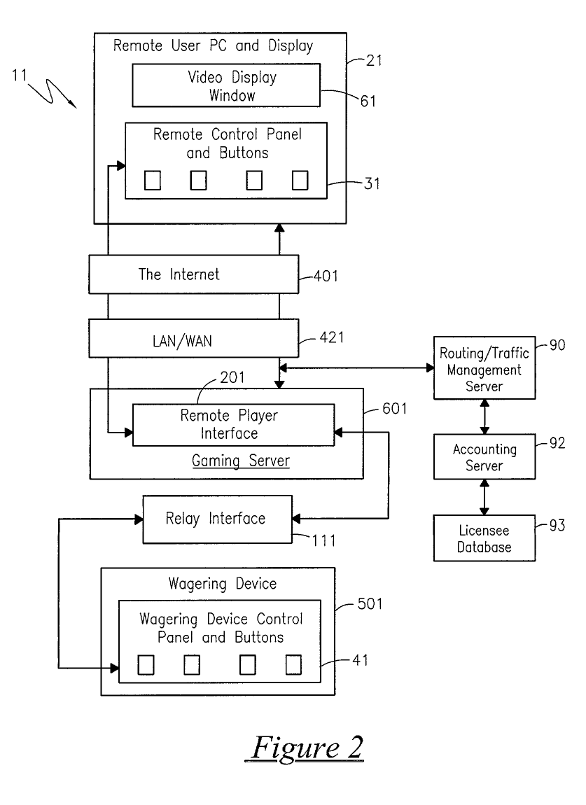

In another embodiment, as illustrated in FIG. 2, a player may access a wagering device 501 through a remote gaming apparatus 11 via a remote user device 21. The remote user device 21 may be a computer or other suitable Internet appliance, such as devices having features including a video display 61, communications capability, input capability (mouse and keyboard or touch screen), and any other suitable features. It is understood that for the purposes of this description, the remote user device 21 is presumed to utilize a mouse and keyboard, rather than touch screen capability; however, any suitable input devices may be utilized. The data transferred to and from the remote user device 21 may be transmitted through a network 401 and a secondary network 421. It is understood that the network 401 may be an Internet-based network or any other suitable network. It is also understood that the secondary network 421 may any suitable communication medium, including a private or virtual private network and may include a telephone link, a hard-wired connection, a satellite link or other wireless connection, a LAN, or a WAN. It is further understood that network 401 and secondary network 421 may be implemented individually or together and that they may be a direct baseband, broadband, or any other suitable network communication medium to which the gaming system is in communication. The features of this embodiment may be employed in conjunction with the elements described above and below.

In one aspect, to gain access to a wagering device 501 of the invention, a gaming server 601 via relay interface and game data serial link 111 may poll one or more wagering devices 501 to determine availability and may query a player's account for account information and available funds. A player may then be presented with a wagering device selection page on the video display 61 of the remote user device 21. This page may display either the physical or the virtual representation of the wagering devices available for play. This page also may initiate a graphically represented pop-up player account control panel that provides current account information and funds available for play. This account window may also provide the user with a graphical representation of his or her funds and the ability to numerically enter, or “drag and drop” funds from his or her account into a selected wagering device.

In this embodiment, a remote player interface 201 is configured within a gaming server 601. The remote player interface 201 may receive serial commands from a remote control panel and buttons 31 within a user device 21 having a video display 61. The commands may be processed through a relay interface and game data serial link 111 to activate corresponding buttons 41 on a wagering device 501. Action confirming serial commands may be sent back to the gaming server 601 and the user device 21. Win, lose, and pay results maybe displayed in the video display 61 of the user device 21. Of course, event archive server 15 and back office financial data server 10, which are described above, may be utilized in connection with the embodiment discussed in association with FIG. 2.

During play in this embodiment, a virtual rendition the wagering device 501 may be displayed on the video display 61 of the user computer 21. Data are transferred to and from the wagering device 501 via a relay interface and game data serial link 111, which, in turn, is in communication with the remote player interface 201 of the gaming server 601. The communication between the remote player interface 201 and the user device 21 is similar to the communication between the remote player interface 20 and the remote user computer 2, described above. In addition, in a preferred embodiment, account verification and tracking of financial information in the remote gaming apparatus 11 is similar to that described with respect to remote gaming apparatus 1, described above.

FIG. 3 illustrates another alternative embodiment of a remote gaming system 110. In this embodiment, a remote player interface 202 within gaming server 602 receives serial commands from a remote control panel located within a user computer having a visual display, as described above. These commands may be processed through a relay interface to activate corresponding buttons 43 on a wagering device 502 in a wagering device slot farm 800. Action confirming serial commands may be sent back to the gaming server 602 and to the user computer, as described above. Win, lose, and pay results may be displayed in the visual display of the user computer. It is understood that the elements not shown in FIG. 3 may be similar to those discussed above or may be of any suitable type. Of course, multiple traffic servers may be employed to accommodate groups of wagering devices 502 as required by bandwidth limitations of network hardware. Additionally, routers and switching hubs may also be used to link networkable components of the system to optimize bandwidth availability.

FIG. 4 depicts yet another alternative embodiment of a remote gaming system 110 where wagering devices 502 may be coupled to gaming servers 602 that may be connected to routing/traffic management server 90 and connected over a local area or wide area network (LAN or WAN) connection. The gaming servers 602 may also be networked to video cameras 702 positioned to capture video images of all the features of the game play with date and time stamps. Commands may be employed to activate corresponding buttons 43 on a wagering device 502 in a wagering device slot farm 800. Action confirming serial commands may be sent back to the gaming server 602 and to the user computer. As above, win, lose, and pay results may be displayed in the visual display of the user computer. Of course, it is understood that the elements not shown in FIG. 4 may be similar to those discussed above or may be of any suitable type.

One function provided by the of the gaming servers 60, 601, 602, 603 of the invention is to interface between the users, video cameras 70, 703, and wagering devices 50, 501, 502. The gaming servers may also maintain a record of all gaming session transaction activity. Each gaming server may use approximately 160 mbps of bandwidth, which may provide about ten gaming servers per T1 line. Of course, the number of users per TI line may be increased by technological improvements or by user acceptance of lesser quality images.

As discussed above, in one embodiment the streaming software employed in the gaming servers 60, 601, 602, 603 detects a user's bandwidth and automatically optimizes the video presentation accordingly. Each gaming server contains a serial remote player interface circuit board and associated interface software that enable a user to view a remote control panel 3 to control the wagering device buttons 31 and perform finds transfer functions. Certain user transactions in a gaming session may be temporarily maintained on the routing/traffic management server 90, wagering device 50, 501, 502, and gaming server attached to the wagering device selected for the play session. A permanent record may be stored on the accounting server 92. The invention seeks to provide the highest transaction speed possible, while protecting against transaction data loss and maintaining acceptable quality.

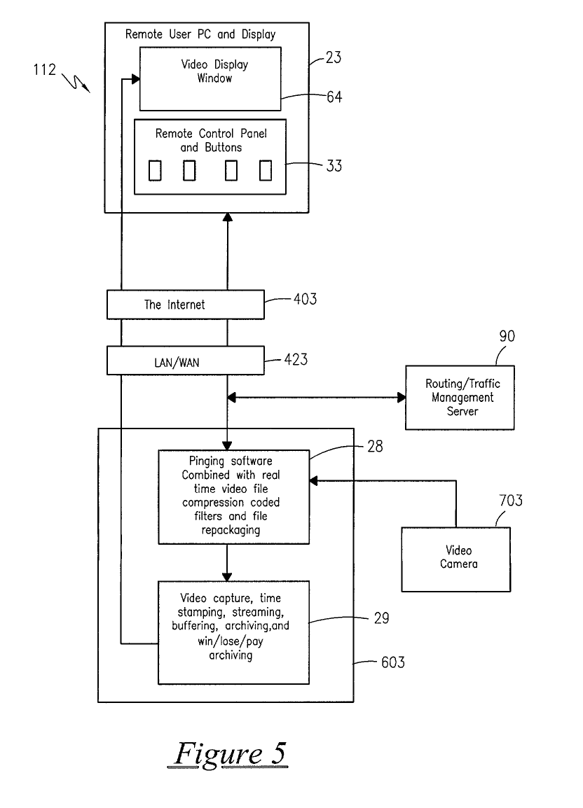

FIG. 5 illustrates a system 112 having automatic bandwidth detection of the connection speed of a remote computer 23 via pinging/video compression software 28, configured within the software architecture of a gaming server 603. The pinging portion of the software is constructed to determine the remote user's connection speed, and the appropriate video file compression codec is applied to a video capture of a wagering device to minimize the bit rate required to transmit the video capture. The video output from video camera 703 may be split into a direct video stream that may be sent to remote users with a high bandwidth connection. A buffered/compressed video stream created from the video output may be archived in video archiving and file generation software 29 (also configured within gaming server 603). This buffered/compressed video stream may also be transmitted to remote users via a low bandwidth connection to be played as a delayed full frame video file on the remote computer 23 via video display 64. It is noted that this automatic bandwidth detection apparatus and method is contemplated for use with all of the embodiments presented herein as well as with any other applications which require video compression through such a scheme. It is further noted that this system 112 is contemplated for use with one or more wagering devices as discussed above and any other suitable combination of elements discussed above.

Several choices for camera video streaming are available, including six to ten second delayed Windows/Real media encoded streaming, less than one second delayed variable compression rate MPEG4 and motion JPEG, or other suitable video streaming options. While higher resolution and frame rates are achievable with encoded streaming, the inherent delay may cause user frustration given the extended wait times for game results. Low latency image distribution is achievable with proprietary MPEG4, but the reduced resolution may diminish user satisfaction due to the subtly fuzzy images. In one embodiment of the invention, if the system senses that a user does not have the latest streaming video “code” on board, then the appropriate updated codec may be sent for download prior to a gaming session.

Audio may be transmitted concurrently with video, or the .wav files may be stored on a user's hard drive to minimize bandwidth usage and may be called as needed by the browser actions. In one embodiment, Wave files identical to the true game sounds may be launched when the game sends a trigger signal from the wagering device software.

The invention will be further described in the following example, which does not limit the scope of the invention described in the claims. The invention contemplates the use of some or all of these parameters, which may be employed in any number of sequences.

### OVERVIEW EXAMPLE

A remote customer using one aspect of the invention described in this specification may encounter the following parameters.

1) A customer may establish a communication link to a routing/traffic management server through any supported Internet browser.

2) The customer's identity may be authenticated utilizing hardware and/or software security checks maintained on an authentication server and in cooperation with the routing/traffic management server.

3) After authentication of the customer's identity, the routing/traffic management server may poll gaming servers and may provide a graphical user interface to display the availability of the wagering devices to the customer.

4) The customer may choose a wagering device from a menu of “hot-linked” graphic representations of banks of wagering devices, including slot machines.

5) The routing/traffic management server may control a router that opens a channel to a gaming server associated with the selected wagering device.

6) The routing/traffic management server may then route the customer to a gaming server that may determine the customer connect speed/throughput capability and may then optimize the wagering device play operation.

7) A video camera interfaced to the gaming server may display an image of the wagering device through a LAN, WAN, the Internet, or any other suitable connection, using a Java or other window in the customer's browser window contained within a pre-installed client software application.

8) A remote control panel, emulating the actual control panel of the selected wagering device, may be displayed below the video display of the wagering device in the customer's browser window.

9) The customer may transfer funds from a customer's enrollment account to a wagering device and may do so multiple times, if desired, during a play session. If the customer logs in via a third-party licensee, then the accounting server may communicate with the associated licensee's funds server for customer logon properties and available funds information in connection with access to the system's wagering devices. If an interface for communication is not available, regular updates from the funds server to the accounting server may be performed. For example, the routing/traffic management server may direct the request for funds to the account database server that then queries the licensee's funds server for the customer's account information and available funds. The buttons on the remote control panel may be disabled awaiting processing. Of course, the steps relating to transfer of funds may be bypassed for contests.

10) If the transfer request is granted, the customer account on the licensee's funds server is decremented by the requested amount. The requested amount and remaining available account balance information may then be determined, stored, and sent to the account database server, routing/traffic management server, and gaming server. If a transfer request is not granted, the customer may receive an appropriate message.

11) Once the gaming server has confirmed receipt of the balance information, the remote control panel may then display the credits transferred and enrollment account balance. The remote control panel buttons may then be enabled.

12) The customer may choose a “bet” amount and activate the wagering device through the remote player interface circuit board, which enables the wagering device for remote play and triggers the buttons on the wagering device in response to commands from the remote customer's actions on the remote control panel in the customer's browser window. The video camera may be activated, and “stream rate” may be adjusted, by the gaming server to stream either video, or a buffered video file, to the remote customer's video display window. If buffered video is needed, the system (either the server computer, network gaming server, or the image capture computer, or combination of these devices, or other suitable conversion and transmission device(s)) converts the video camera output to a compressed video file, and transmits the file to the remote customer's computer, where it may be played back in either a Java window, or within Real Player, Windows Media Player, or some equivalent software. Audio may be provided to enhance the gaming experience through either audio streaming, client computer resident .WAV files, or the like, associated with the appropriate events occurring on each wagering device.

13) With specificity regarding betting, the customer then may select a bet amount by clicking the “bet one” or “bet max” buttons on the remote control panel. The remote control panel may display the “bet” field incremented and the “credits” field decremented. The customer may then select the “spin” or “deal draw” button on the remote control panel to start the game. If “bet max” is selected, then the game will automatically start. In one aspect, all buttons on the remote control panel may then be disabled. When the game ends, the camera server “credits” may be transferred to the accounting server for storing in the transaction detail and balance reconciliation databases. The buttons on the remote control panel may be enabled when a “Current Credits” update and balance update from the accounting server is received, and a “Credits” field update is processed by the gaming server database. The betting steps may be repeated by the customer: (a) until there are zero credits on the remote control panel; (b) until the customer transfers remaining credits back to the customer's enrollment account located in the system's funds server; (c) until the customer transfers remaining credits back to the customer's enrollment account located in the licensee's funds server; or (d) the customer changes wagering devices.

14) The win/loss result of each wagering device event may be reflected in an updated credit balance of the remote customer's browser window, as well as recorded in the gaming server and the accounting server. The system may track detailed session information including customer and licensee identification, time played for each device, wagering device identification, win/loss amounts, funds transfer transactions, and date/time stamp of all transactions. Game play records and accounting may be kept on the wagering device, accounting server, and on the applicable camera server controlling the device in play. In one aspect, the accounting server will maintain a permanent record.

When a remote customer leaves the system or changes wagering devices, the customer's funds account balance may be reconciled based on the difference between the credits remaining and the total credits transferred by the customer from a licensee funds database. This amount may be recorded in the slot bank database located in the accounting server. Customer win amounts may be subtracted from the applicable third-party licensee float account balance and customer losses are added to the balance and may employ the interstitial or ancillary account servers to do so. Each licensee may maintain a minimum balance in a float account, which emulates a slot bank, with the system server. It is to be understood that the embodiments and variations shown and described herein are merely illustrative of the principles of this invention and that various modifications may be implemented by those skilled in the art without departing from the scope and spirit of the invention. It is to be further understood that the scope of the invention presented herein contemplates any combination of elements from the various embodiments disclosed herein.

What is claimed is:

1. An interactive gaming system comprising:
a user computer;
a data network in communication with said user computer;
a gaming server in communication with said data network; and
at least one wagering device in communication with said gaming server, said wagering device being located remotely from said user computer;
wherein said user computer remotely controls said at least one wagering device.

2. The system of claim 1 further comprising a video camera in communication with said gaming server.

3. The system of claim 1 further comprising a fmancial data server in communication with said gaming server.

4. The system of claim 1 further comprising a routing/traffic management server in communication with said gaming server.

5. The system of claim 1 further comprising an archive data server in communication with said gaming server.

6. The system of claim 1 further comprising an archive data server in communication with said gaming server, wherein said archive data server comprises a date and time stamping unit.

7. The system of claim 1 further comprising a relay switching and serial data interface in communication with said gaming server and said at least one wagering device.

8. The system of claim 1 wherein said gaming server further comprises a file compression codec filter.

9. The system of claim 1 wherein said system transmits information in real time.

10. The system of claim 1 comprising a bandwidth and transmission detection device, wherein transmissions between said user computer and said wagering device are optimized using encryption and compression techniques.

11. An interactive gaming system comprising:
means for communicating between a remotely located computer and a wagering device; and
means for entering commands into the computer to operate and control the wagering device.

12. A method for permitting a remotely located player to control a wagering device comprising:
using a remotely located computer to communicate with the wagering device; and
entering commands into the computer to operate and control the wagering device.

13. The method of claim 12 further comprising remote viewing of the wagering device.

14. The method of claim 12 wherein using a remotely located computer to communicate with the wagering device further comprises communicating through a data network.

15. The method of claim 12 wherein using a remotely located computer to communicate with the wagering device further comprises communicating through a gaming server.

16. The method of claim 12 further comprising accessing personal financial information through the remotely located computer.

17. The method of claim 12 further comprising accessing personal financial information through the remotely located computer and transferring money from a player's account to the wagering device.

18. The method of claim 12 further comprising:
accessing personal financial information through the remotely located computer;
transferring money from a player's account to a deposit account, authorizing a player access to play the wagering device based on a status of the deposit account; and
transferring relative gains or losses between the deposit account and the player's account.

19. The method of claim 12 further comprising:
accessing personal financial information through the remotely located computer;
transferring money from a player's account to a deposit account, authorizing a player access to play the wagering device based on a status of the deposit account;
playing another wagering device or other game of chance using the deposit account; and
transferring relative gains or losses between the deposit account and the player's account.

20. The method of claim 12 further comprising reviewing actions taken by the player and results generated by the wagering device on the remotely located computer.

21. The method of claim 12 wherein operating the wagering device comprises entering commands into the wagering device using a proxy.

22. The method of claim 12 wherein the proxy is human.

23. The method of claim 12 wherein the proxy is non-human.

24. The method of claim 12 further comprising detection of the player's connection bandwidth and transmission speed.

25. The method of claim 12 further comprising detection of the player's connection bandwidth and transmission speed, wherein the detection is automatic.

26. The method of claim 12 further comprising optimizing transmitted information based upon detected bandwidth and transmission speed.

27. The method of claim 12 further comprising optimizing transmitted information based upon detected bandwidth and transmission speed, wherein optimizing comprises selecting appropriate encryption or compression techniques.

28. The method of claim 12 further comprising polling at least one wagering device to determine availability.

29. The method of claim 28 further comprising providing a graphical user interface associated with the wagering device polled for availability.

30. The method of claim 29 further comprising selecting an available wagering device using the graphical user interface.

31. The method of claim 12 further comprising polling at least one gaming server to determine availability.

32. The method of claim 12 further comprising:
transferring money from a player's account to an interstitial account server,
authorizing a player to play the wagering device based on a status of the interstitial account server, and
transferring relative gains or losses between the interstitial account server and the player's account.

33. The method of claim 12 further comprising:
communicating the status of the player's account in an external database with a routing/traffic management server, the player's external database managed by a casino operator,
authorizing a player to communicate with a routing/traffic management server based on a status of the player's account,
permitting a player to play the wagering device based on an authentication check of the player, and
transferring relative gains or losses between a slot bank and the player's external account.

34. A method for permitting a remotely located player to control a wagering device comprising the steps of:
using a remotely located computer to communicate with the wagering device; and
entering commands into the computer to operate the wagering device.

35. In a system for remotely controlling at least one wagering device using a user computer, a computer-readable memory for storing data for access by an application program comprising:
a data structure stored in said computer-readable memory, said data structure including information used by said application program and including:
a plurality of personal data fields;
a plurality of financial fields;
a plurality of wagering device control fields;
a plurality of wagering fields;
a plurality of results fields;
wherein said fields have values and said application program controls the operation of the at least one wagering device.

36. The data structure of said computer-readable memory of claim 35 further comprising a plurality of video display fields.

37. The data structure of said computer-readable memory of claim 35, wherein said plurality of financial fields comprise a plurality of account balance fields.

38. The data structure of said computer-readable memory of claim 35 further comprising a plurality of archival fields.

39. The data structure of said computer-readable memory of claim 35 further comprising a plurality of date and time fields.

40. The data structure of said computer-readable memory of claim 35 further comprising a plurality of bandwidth fields.

41. The data structure of said computer-readable memory of claim 35 further comprising a plurality of transmission speed fields.
